(19) United States
(12) Patent Application Publication
(10) Pub. No.: US 2026/0084617 A1
(43) Pub. Date: Mar. 26, 2026

(54) System for Automatically Adjusting Mirrors and Related Methods

(71) Applicant: ZF Friedrichshafen AG, Friedrichshafen (DE)

(72) Inventor: Srinadh Vanapalli, Hyderabad (IN)

(21) Appl. No.: 18/894,578

(22) Filed: Sep. 24, 2024

(51) Int. Cl. B60R 1/072; B60R 1/074

(52) U.S. Cl. CPC B60R 1/072; B60R 1/074

(57) ABSTRACT

A system includes a controller, a mirror assembly, and a sensor. The mirror assembly is electrically connected to the controller and includes a housing and a mirror disposed within the housing. The mirror is configured to move relative to the housing. The controller is configured to control movement of the mirror. The sensor is electrically connected to the controller and is configured to collect data associated with a driver of a vehicle. The controller is configured to receive the data associated with the driver, determine a set of physical characteristics of the driver based on the data, and automatically move the mirror from a first position to a second position based on the set of physical characteristics of the driver.

### FIELD

The present disclosure relates to a system for automatically adjusting mirrors and more particularly to a system for automatically adjusting mirrors that may be used in connection with vehicles.

### BACKGROUND

Traditionally, vehicle side mirrors are adjusted manually, via mechanical or electrical controls, by a driver of a vehicle. Adjusting the side mirrors while driving may be distracting for the driver. Distracted driving significantly increases the risk of accidents, as it impairs the driver's ability to focus on the road, react to hazards, and make safe driving decisions. Therefore, there is a need for a system for automatically adjusting mirrors of a vehicle to reduce distracted driving.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a system. The system includes a controller, a mirror assembly, and a sensor. The mirror assembly is electrically connected to the controller and includes a housing and a mirror disposed within the housing. The mirror is configured to move relative to the housing. The controller is configured to control movement of the mirror. The sensor is electrically connected to the controller and is configured to collect data associated with a driver of a vehicle. The controller is configured to receive the data associated with the driver, determine a set of physical characteristics of the driver based on the data, and automatically move the mirror from a first position to a second position based on the set of physical characteristics of the driver.

Another aspect of the disclosure provides a method. The method includes receiving, via a controller, data associated with a driver of a vehicle. The data is collected by a sensor. The method includes determining, via the controller, a set of physical characteristics of the driver based on the data. The method includes automatically moving, via the controller, a mirror of the vehicle from a first position to a second position based on the set of physical characteristics of the driver.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a schematic view of an example system for automatically adjusting mirrors in accordance with the principles of the present disclosure.

FIG. 2 is a functional block diagram of an example mirror assembly of the system of FIG. 1 in accordance with the principles of the present disclosure.

FIG. 3A is a perspective view of an example mirror assembly of the system of FIG. 1 in a first position in accordance with the principles of the present disclosure.

FIG. 3B is a perspective view of an example mirror assembly of the system of FIG. 1 in a second position in accordance with the principles of the present disclosure.

FIG. 4 is a perspective view of moving a mirror assembly of the system of FIG. 1 from an operational configuration to a nonoperational configuration in accordance with the principles of the present disclosure.

FIG. 5A is a perspective view of operating the system of FIG. 1 in accordance with the principles of the present disclosure.

FIG. 5B is a side view of operating the system of FIG. 1 in accordance with the principles of the present disclosure.

FIGS. 6A, 6B, and 6C are perspective views of operating the system of FIG. 1 in accordance with the principles of the present disclosure.

FIG. 7 is a flowchart of an example method for operating the system of FIG. 1 in accordance with the principles of the present disclosure.

In the drawings, reference numbers may be reused to identify similar and/or identical elements.

### DETAILED DESCRIPTION

### Introduction

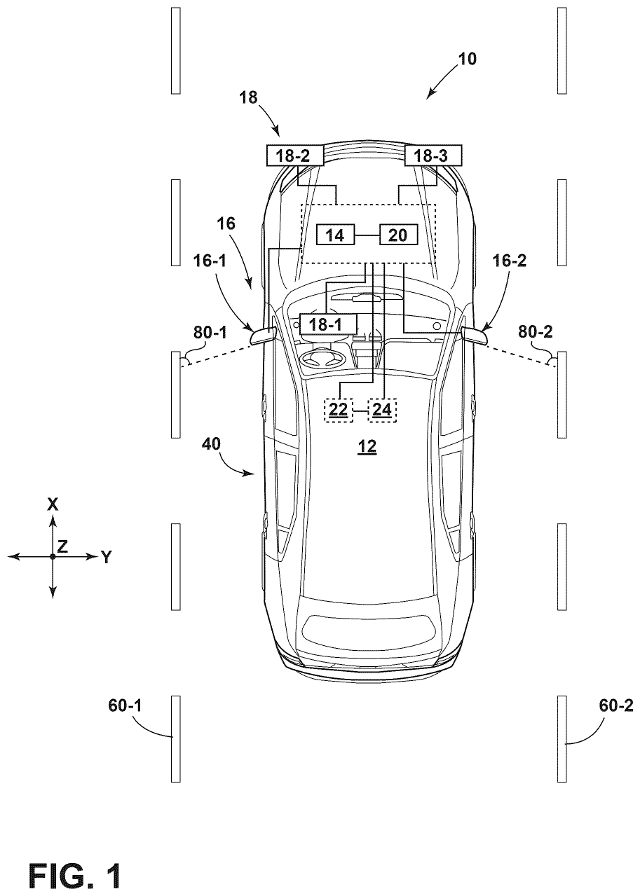

With reference to FIG. 1, an example system 10 for automatically adjusting mirrors is shown. In various implementations, the system 10 may be used in connection with and/or may be disposed within a vehicle 12 (e.g., an automobile). The system 10 may include a controller 14, a first mirror assembly 16-1, a second mirror assembly 16-2, a plurality of sensors 18 (e.g., sensors 18-1, 18-2, 18-3, etc.), one or more batteries 20, a seat module 22, and/or one or more seat motors 24, among others. In various implementations, the seat module 22 and the seat motors 24 may be disposed in and/or connected to a seat 26 of the vehicle 12 (e.g., a driver's seat). As explained in further details below, the system 10 automatically adjusts the first mirror assembly 16-1 and/or the second mirror assembly 16-2, for example, based on a set of physical characteristics of a driver of the vehicle 12 to reduce distracted driving by the driver.

### Controller

With continued reference to FIG. 1, in various implementations, the controller 14 may be electrically connected to the first mirror assembly 16-1, the second mirror assembly 16-2, the plurality of sensors 18, the one or more batteries 20, the seat module 22, and/or the seat motors 24, among others. The controller 14 may receive data and/or information from the plurality of sensors 18, the first mirror assembly 16-1, the second mirror assembly 16-2, the seat module 22, and/or the seat motors 24, among others. In various implementations, the controller 14 may determine the set of characteristics of the driver based on data and/or information received from the first sensor 18-1, the seat module 22, and/or the seat motors 24, among others.

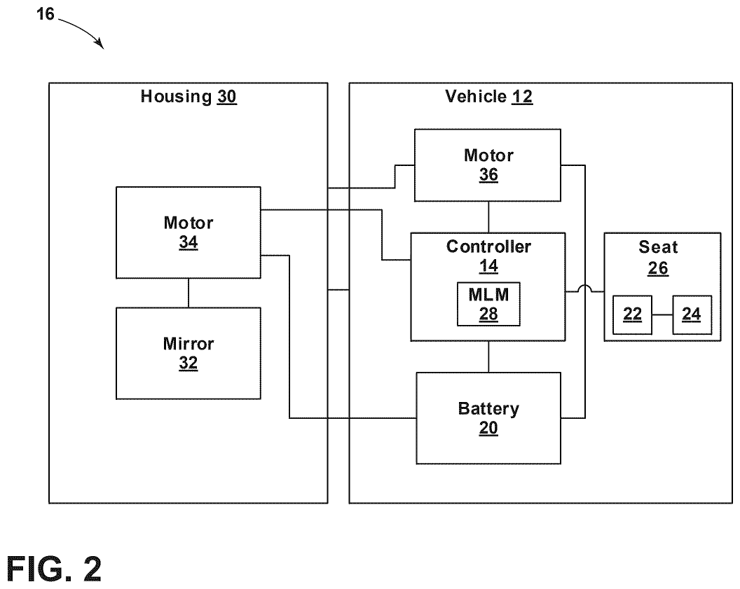

Referring now to FIG. 2, in various implementations, the controller 14 may include and/or may use a machine learned model 28. In various implementations, the machine learned model 28 may be used to determine future positions of a mirror 32 of a mirror assembly 16 (e.g., the first mirror assembly 16-1, the second mirror assembly 16-2), for example, based on the set of physical characteristics of the driver of the vehicle 12. In various implementations, the machine learned model 28 may use data and/or information from the plurality of sensors 18, the seat module 22, the seat motors 24, and/or data and/or information associated with the set of physical characteristics of the driver of the vehicle 12, among others, as inputs and/or to train or retrain the machine learned model 28.

As explained in further details below, the controller 14 may control operation and movement of the first mirror assembly 16-1 and the second mirror assembly 16-2, among others.

In various implementations, the controller 14 includes an electronic controller and/or an electronic processor, such as a programmable microprocessor and/or microcontroller. The controller 14 may include an application specific integrated circuit (ASIC). The controller 14 may include a central processing unit (CPU), a memory (e.g., a non-transitory computer-readable storage medium), and/or an input/output (I/O) interface. The controller 14 may perform various functions, including those described in greater detail herein, with appropriate programming instructions and/or code embodied in software, hardware, and/or other medium. The controller 14 may include a plurality of controllers. The controller 14 may be connected to a display, such as a touch screen.

### Mirror Assembly

With reference to FIG. 2, in various implementations, a mirror assembly 16 (e.g., the first mirror assembly 16-1, the second mirror assembly 16-2, etc.) may include a housing 30, a mirror 32, and/or motor 34, among others. In some example configurations, the mirror 32 and/or the motor 34 may be disposed within and/or may be connected, at least indirectly, to the housing 30. The mirror 32 may be connected, at least indirectly, to the motor 34. The mirror 32 may move (e.g., rotate, pivot, etc.) relative to the housing 30 in the X-direction, the Y-direction, and/or the Z-direction.

In various implementations, the motor 34 may be electrically connected to the controller 14 and a battery 20 of the vehicle 12. The motor 34 drives the movement of the mirror 32. The battery 20 supplies power to the motor 34. The controller 14 controls the motor 34 and the movement of the mirror 32 relative to the housing 30.

Referring again to FIG. 1, in various implementations, the first mirror assembly 16-1 and the second mirror assembly 16-2 may be connected to a body 40 of a vehicle 12. In some example configurations, the first mirror assembly 16-1 may be connected to the driver side of the vehicle 12 and the second mirror assembly 16-2 may be connected to the passenger side of the vehicle. While the system 10 is generally described and depicted herein as including two mirror assemblies 16, the system 10 may include more or less than two mirror assemblies 16. For example, the system 10 may include a third mirror assembly 16 (not depicted) that may be a rearview mirror assembly and/or may be disposed within the vehicle 12.

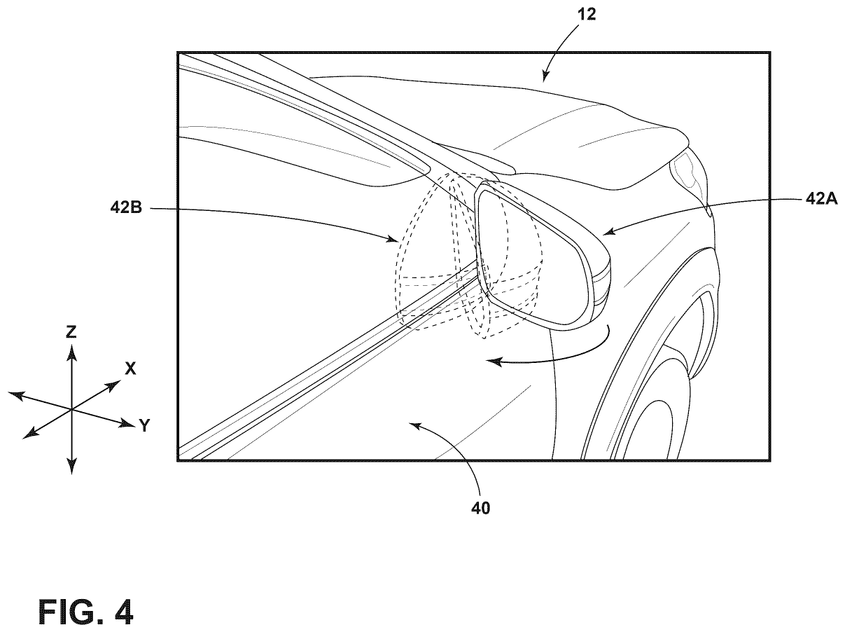

With reference to FIG. 4, in various implementations, a mirror assembly 16 (e.g., the first mirror assembly 16-1, the second mirror assembly 16-2, etc.) may move (e.g., rotate, pivot, translate, etc.) relative to the body 40 of the vehicle 12. For example, the mirror assembly 16 may move from an operational configuration 42A to a nonoperational configuration 42B. The mirror assembly 16 extends from the body 40 of the vehicle 12 when in the operational configuration 42A. The mirror assembly 16 is in the operational configuration 42A during operation of the vehicle 12 (e.g., when the vehicle 12 is running and/or moving). In various implementations, the mirror assembly 16 may be in a folded configuration in the nonoperational configuration 42B. The mirror assembly 16 may be in the nonoperational configuration 42B when the vehicle 12 is in a parked state and/or an off state (e.g., not in operation) such that risk of damage to the mirror assembly 16 is reduced.

Referring again to FIG. 2, in various implementations, the vehicle 12 may include a motor 36. In some example configurations, the motor 36 may be connected, at least indirectly, to a housing 30 of a mirror assembly 16 (e.g., the first mirror assembly 16-1, the second mirror assembly 16-2, etc.). The motor 36 may be electrically connected to the controller 14 and the battery 20. The motor 36 may drive the movement of the mirror assembly 16, for example, from the operational configuration 42A to the nonoperational configuration 42B or vice versa. The controller 14 controls the motor 36 and the movement of the mirror assembly 16 relative to the body 40 of the vehicle 12. The battery 20 supplies the motor 36 power.

### Sensor

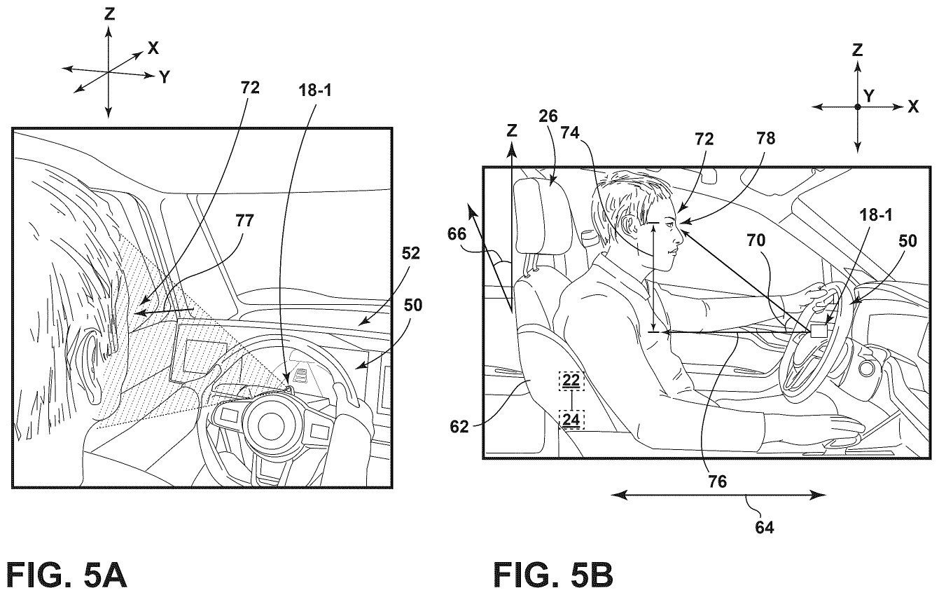

With reference to FIGS. 1, 5A, and 5B, each sensor of the plurality of sensors 18 (e.g., sensors 18-1, 18-2, 18-3, etc.) may include an infrared light-emitting diode and/or a camera, among others. In various implementations, the system 10 may include a first sensor 18-1, a second sensor 18-2, and a third sensor 18-3, among others. The first sensor 18-1, the second sensor 18-2, and the third sensor 18-2 are electrically connected to the controller 14 and may transmit data and/or information to the controller 14.

In some example configurations, the first sensor 18-1 may be disposed proximate a steering wheel 50 of the vehicle 12. For example, the first sensor 18-1 may be connected to the steering wheel 50 or a dash 52 of the vehicle 12, among others. As will be explained in further details below, the first sensor 18-1 collects data associated with the driver of the vehicle 12.

In some example configurations, the second sensor 18-2 and the third sensor 18-3 may be connected to the body 40 of the vehicle 12 proximate the front of the vehicle 12. In some instances, the second sensor 18-2 may be disposed proximate the driver side of the vehicle 12, and the third sensor 18-3 may be disposed proximate the passenger side of the vehicle 12. In various implementations, the second sensor 18-2 and the third sensor 18-3 may collect data associated with objects (e.g., traffic lines, other vehicles, pedestrians, etc.) and/or the environment (e.g., road conditions, weather, etc.) located proximate the vehicle 12. In some examples, the second sensor 18-2 may collect data associated with one or more traffic lines 60-1 located proximate the driver side of the vehicle 12, and the third sensor 18-3 may collect data associated with one or more traffic lines 60-2 located proximate the passenger side of the vehicle 12.

### Vehicle Seat

With reference to FIGS. 2 and 5B, the seat 26 may include and/or may be connected to the seat module 22 (e.g., a driver seat module, a memory seat module, etc.) and/or the seat motors 24, among others. The seat module 22 may be electrically connected with the seat motors 24. In various implementations, the seat module 22 and/or the controller 14 may control operation of the seat motors 24 and/or movement of the seat 26. The seat motors 24 may drive the movement of the seat 26. In various implementations, the seat 26 may move in the X-direction along a floor of the vehicle 12 (e.g., towards or away from the steering wheel 50). In various implementations, a seat back 62 of the seat 26 may pivot relative to the Z-axis.

In various implementations, the controller 14 and/or the seat module 22 may determine a position 64 of the seat 26 relative to the steering wheel 50 based on data and/or information from a seat motor 24. In some examples, the data and/or information may be associated with a current position of the seat motor 24. In various implementations, the controller 14 and/or the seat module 22 may determine an angle 66 of the seat back 62 relative to the Z-axis (e.g., seat incline) based on data and/or information from a seat motor 24.

### Operation of System

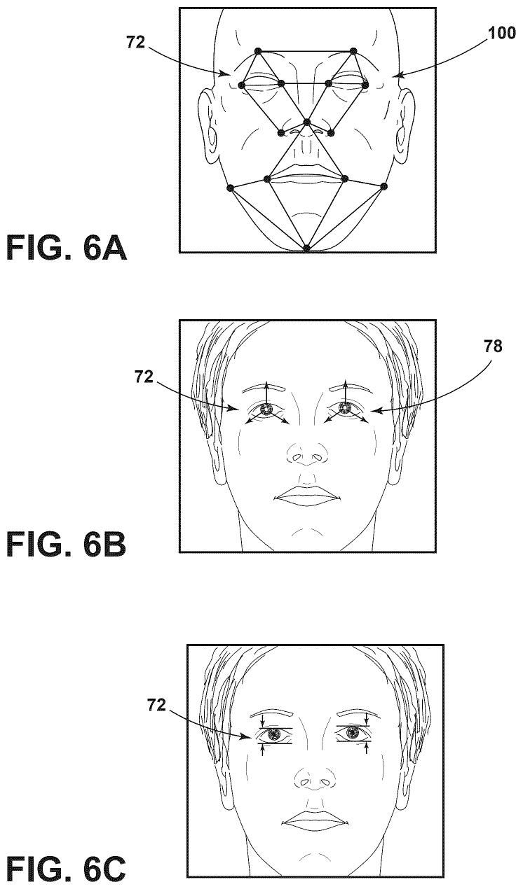

With reference to FIGS. 5A, 5B, and 6B, in various implementations, the controller 14 determines a set of physical characteristics of the driver based on data and/or information received from the first sensor 18-1, the seat module 22, and/or the seat motors 24, among others. In some examples, the set of physical characteristics may include an angle 70 of at least one eye 72 of the driver relative to the first sensor 18-1 (e.g., relative to the X-direction), a height 74 of the driver and/or at least one eye 72 of the driver relative to the first sensor 18-1 (e.g., in the Z-direction), a distance 76 of the at least one eye 72 from the first sensor 18-1 (e.g., in the X-direction), and/or a lateral position 77 of the at least one eye 72 relative to the first sensor 18-1 (e.g., in the Y-direction), among others.

In various implementations, the controller 14 may determine the set of physical characteristics by determining an initial location 78 (e.g., an XY position, an XYZ position, etc.) of the at least one eye 72 of the driver. Next, the controller 14 may determine the angle 70 of the at least one eye 72 of the driver relative to the first sensor 18-1 based on the initial location 78. Subsequently, the controller 14 may determine the height 74 of the driver and/or the at least one eye 72 (e.g., in the Z-direction) and the distance 76 of the driver and/or the at least one eye 72 (e.g., in the X-direction) from the first sensor 18-1 based on the angle 70 of the at least one eye 72 of the driver relative to the X-direction. Next, the controller 14 may determine the lateral position 77 of the at least one eye 72 (e.g., in the Y-direction) relative to the first sensor 18-1.

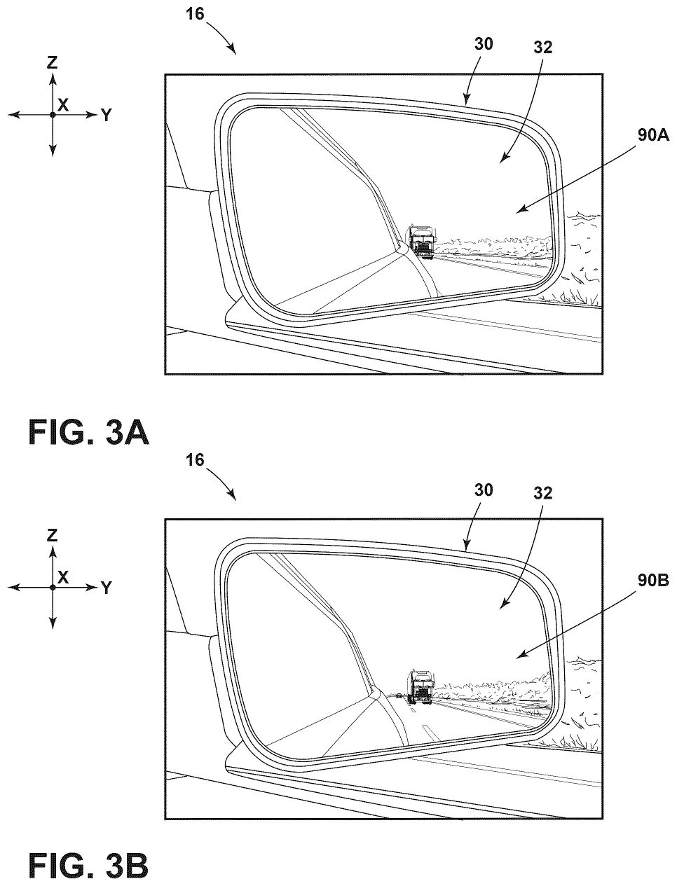

With reference to FIGS. 3A and 3B, in various implementations, the controller 14 automatically adjusts (e.g., without human intervention) a position of a mirror 32 of a mirror assembly 16-1, 16-2 based on the set of physical characteristics of the driver by moving the mirror 32 from a first position 90A (see, e.g., FIG. 3A) to a second position 90B (see, e.g., FIG. 3B). In various implementations, the controller 14 determines the second position 90B based on the set of physical characteristics of the driver. The controller 14 may send a control signal to a motor 34 of the mirror assembly 16-1, 16-2 to move the mirror 32 to the second position 90B. The driver has an obstructed view (e.g., of the environment, objects, other vehicles, and/or pedestrians located proximate the vehicle 12) when the mirror 32 is in the first position 90A and the driver has an unobstructed view (e.g., of the environment, objects, other vehicles, and/or pedestrians located proximate the vehicle 12) when the mirror 32 is in the second position 90B.

Referring now to FIG. 1, in various implementations, the first position 90A of the mirror 32 is associated with a default position. In some examples, the default position is associated with a determined angle (e.g., angle 80-1, 80-2) of the mirror 32 relative to a traffic line 60-1, 60-2 located proximate the vehicle 12 (e.g., 40 degrees, etc.). In some instances, the default position is associated with a position of the mirror 32 that accommodates an average sized human (e.g., 5 feet 9 inches for a male, 5 feet 4 inches for a female, etc.). For example, the average sized human may not have an obstructed view when the mirror 32 is in the first position 90A. In various implementations, the controller 14 may determine a position of the mirror 32 relative to a traffic line 60-1, 60-2 located proximate the vehicle 12 based on data from the second sensor 18-2 and/or the third sensor 18-3.

In various implementations, the second position 90B is different than the first position 90A. The second position 90B accommodates for the set of physical characteristics of the driver such that the driver has an unobstructed view when the mirror is in the second position 90B. For example, for a driver that is taller than the average sized driver, the second position 90B may include an angle of the mirror 32 relative to a traffic line 60-1, 60-2 (e.g., 45 degrees, etc.) that is greater than the determined angle of the mirror 32 when the mirror 32 is in the first position 90A (e.g., 40 degrees, etc.). For a driver that is shorter than the average sized driver, the second position 90B may include an angle of the mirror 32 relative to a traffic line 60-1, 60-2 (e.g., 30 degrees, etc.) that is less than the determined angle of the mirror 32 when the mirror 32 is in the first position 90A.

In various implementations, the controller 14 may use the machine learned model 28 to determine the second position 90B of the mirror 32. In various implementations, the machine learned model 28 may use data and/or information from the plurality of sensors 18 (e.g., sensors 18-1, 18-2, 18-3, etc.), the seat module 22, and/or the seat motors 24, among others, as inputs. In various implementations, the machine learned model 28 may use the set of physical characteristics of the driver, the position 64 of the seat 26, and/or the angle 66 of the seat back 62, among others, as inputs. The machine learned model 28 may generate the second position 90B as an output and the controller 14 may automatically adjust the position of the mirror 32 based on the generated output.

With reference to FIGS. 6A and 6C, in various implementations, the controller 14 may determine the identity of the driver based on data and/or information from the first sensor 18-1. For example, the controller 14 may determine a set of features 100 that help facilitate the identification of the driver. The set of features 100 may include eye shape, eye color, eye position, nose shape, nose size, mouth shape, mouth size, chin shape, and/or chin size, among others. In some examples, the identity of the driver may be used to determine the second position 90B of the mirror 32. For example, the identity of the driver may be associated with a determined second position 90B and the controller 14 may automatically move a mirror 32 to the determined second position after the identity of the driver is determined.

In various implementations, the controller 14 may determine a status of the at least one eye 72 of the driver. The status of the at least one eye 72 may include that the at least one eye 72 is open, the at least one eye 72 is closed, and/or the frequency at which the at least one eye 72 is blinking, among other. In some examples, the identification of the driver and/or the status of the at least one eye 72 of the driver may be used as inputs to the machine learning model 28 to help generate the second position of the mirror 32.

With reference to FIG. 4, in various implementations, the controller 14 may automatically move a mirror assembly 16-1, 16-2, relative to the body 40 of the vehicle 12, from an operational configuration 42A to a nonoperational configuration 42B when the vehicle 12 is in at least one of a parked state or in an off state to reduce the risk of damage to the mirror assembly 16-1, 16-2.

### Flowchart

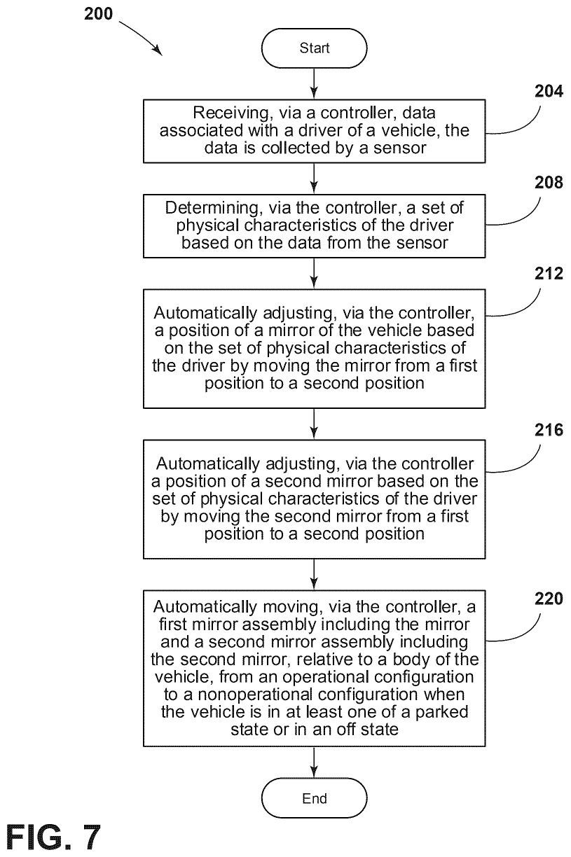

FIG. 7 is a flowchart of an example method 200 of operating the system 10. The method 200 may begin at 204. At 204, the controller 14 may receive data and/or information associated with a driver of a vehicle 12 from a sensor 18-1. The method 200 may proceed to 208.

At 208, the controller 14 may determine a set of physical characteristics of the driver based on the data and/or information from the sensor 18-1. In various implementations, the controller 14 may determine the set of physical characteristics of the driver by determining an initial location 78 of at least one eye 72 of the driver. Next, the controller 14 may determine an angle 70 of the at least one eye 72 of the driver relative to the sensor 18-1 based on the initial location 78. Subsequently, the controller 14 may determine a height 74 of the driver and a distance 76 of the driver from the sensor 18-1 based on the angle 70 of the at least one eye 72. The method 200 may proceed to 212.

At 212, the controller 14 may automatically adjust a position of the first mirror 32 of the first mirror assembly 16-1 of the vehicle 12 based on the set of physical characteristics of the driver by moving the mirror from a first position 90A (e.g., a default position) to a second position 90B. In various implementations, the driver has an obstructed view when the first mirror 32 is in the first position 90A. The second position 90B accommodates for the set of physical characteristics of the driver such that the driver has an unobstructed view when the first mirror 32 is in the second position 90B. The method 200 may proceed to 216.

At 216, the controller 14 may automatically adjust a position of the second mirror 32 of the second mirror assembly 16-2 based on the set of physical characteristics of the driver by moving the second mirror 32 from a first position 90A to a second position 90B. In various implementations, the driver has an obstructed view when the second mirror 32 is in the first position 90A. The second position 90B accommodates for the set of physical characteristics of the driver such that the driver has an unobstructed view when the second mirror 32 is in the second position 90B. In various implementations, the controller 14 may use a machine learned model 28 to determine the second position 90B of the first mirror 32 and/or the second mirror 32. The machine learned model 28 may use at least one of: the data from the sensor 18-1 or the set of physical characteristics as an input. The method 200 may proceed to 220.

At 220, the controller 14 may automatically move the first mirror assembly 16-1 including the first mirror 32 and the second mirror assembly 16-2 including the second mirror 32, relative to the body 40 of the vehicle 12, from an operational configuration 42A to a nonoperational configuration 42B when the vehicle 12 is in at least one of a parked state or in an off state. Then the method 200 may end.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed. ” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit. ” In this application, the term “controller” can be replaced with the term “module. ” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”).

The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods.

The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C. ” The phrase “at least one of A, B, or C” should be construed to mean a logical (A OR B OR C), using a non-exclusive logical OR.

The following Clauses provide an exemplary configuration for a system for automatically adjusting mirrors and related methods, as described above.

Clause 1: A system comprising: a controller; a mirror assembly electrically connected to the controller and including a housing and a mirror disposed within the housing, wherein: the mirror is configured to move relative to the housing, and the controller is configured to control movement of the mirror; and a sensor electrically connected to the controller and configured to collect data associated with a driver of a vehicle; wherein the controller is configured to: receive the data associated with the driver, determine a set of physical characteristics of the driver based on the data, and automatically move the mirror from a first position to a second position based on the set of physical characteristics of the driver.

Clause 2: The system of clause 1, wherein the data associated with the driver of the vehicle includes at least one of: a position of a seat of the driver or an angle of a seat back of the seat.

Clause 3: The system of clause 1 or 2, wherein the set of physical characteristics includes at least one of: an initial location of at least one eye of the driver, an angle of the at least one eye relative to the sensor, a height of the driver, or a distance of the at least one eye from the sensor.

Clause 4: The system of any of clauses 1 through 3, wherein the controller is configured to: determine an initial location of at least one eye of the driver; determine an angle of the at least one eye of the driver relative to the sensor based on the initial location; and determine a height of the driver and a distance of the driver from the sensor based on the angle of the at least one eye of the driver to define the set of physical characteristics of the driver.

Clause 5: The system of any of clauses 1 through 4, wherein the first position of the mirror is associated with a default position.

Clause 6: The system of clause 5, wherein the default position is associated with a determined angle of the mirror relative to a traffic line located proximate the vehicle.

Clause 7: The system of any of clauses 1 through 6, wherein: the controller is configured to determine the second position based on the set of physical characteristics of the driver; the second position is different than the first position; the driver has an obstructed view when the mirror is in the first position; and the second position accommodates for the set of physical characteristics of the driver such that the driver has an unobstructed view when the mirror is in the second position.

Clause 8: The system of any of clauses 1 through 7, wherein: the controller is configured to use a machine learned model to determine the second position of the mirror; and the machine learned model is configured to use at least one of the data from the sensor or the set of physical characteristics as an input.

Clause 9: The system of any of clauses 1 through 8, wherein: the system includes a second sensor; and the controller is configured to determine a position of the mirror relative to a traffic line located proximate the vehicle based on data from the second sensor.

Clause 10: The system of any of clauses 1 through 9, wherein: the system includes a second mirror assembly having a second mirror; and the controller is configured to automatically adjust a position of the second mirror based on the set of physical characteristics of the driver by moving the second mirror from a first position to a second position.

Clause 11: The system of any of clauses 1 through 10, wherein the controller is configured to automatically move the mirror assembly, relative to a body of the vehicle, from an operational configuration to a nonoperational configuration when the vehicle is in at least one of a parked state or an off state.

Clause 12: A vehicle comprising: the system of claim 1; and a steering wheel, wherein the sensor is disposed proximate the steering wheel.

Clause 13: A method comprising: receiving, via a controller, data associated with a driver of a vehicle, wherein the data is collected by a sensor; determining, via the controller, a set of physical characteristics of the driver based on the data; and automatically moving, via the controller, a mirror of the vehicle from a first position to a second position based on the set of physical characteristics of the driver.

Clause 14: The method of clause 13, wherein: the sensor is disposed proximate a steering wheel of the vehicle; and the set of physical characteristics includes at least one of: an initial location of at least one eye of the driver, an angle of the at least one eye relative to the sensor, a height of the driver, or a distance of the driver from the sensor.

Clause 15: The method of clause 13 or 14, wherein determining the set of physical characteristics of the driver includes: determining, via the controller, an initial location of at least one eye of the driver; determining, via the controller, an angle of the at least one eye of the driver relative to the sensor based on the initial location; and determining, via the controller, a height of the driver and a distance of the driver from the sensor based on the angle of the at least one eye.

Clause 16: The method of any of clauses 13 through 15, wherein: the driver has an obstructed view when the mirror is in the first position; and the second position accommodates for the set of physical characteristics of the driver such that the driver has an unobstructed view when the mirror is in the second position.

Clause 17: The method of any of clauses 13 through 16, wherein: the controller is configured to use a machine learned model to determine the second position of the mirror; and the machine learned model is configured to use at least one of the data from the sensor or the set of physical characteristics as an input.

Clause 18: The method of any of clauses 13 through 17, further comprising determining, via the controller, a position of the mirror relative to a traffic line located proximate the vehicle based on data from a second sensor.

Clause 19: The method of any of clauses 13 through 18, further comprising automatically adjusting, via the controller a position of a second mirror based on the set of physical characteristics of the driver by moving the second mirror from a first position to a second position.

Clause 20: The method of any of clauses 13 through 19, further comprising automatically moving, via the controller, a mirror assembly including the mirror, relative to a body of the vehicle, from an operational configuration to a nonoperational configuration when the vehicle is in at least one of a parked state or an off state.

1. A system comprising:
a controller;
a mirror assembly electrically connected to the controller and including a housing and a mirror disposed within the housing, wherein:
the mirror is configured to move relative to the housing, and
the controller is configured to control movement of the mirror; and
a sensor electrically connected to the controller and configured to collect data associated with a driver of a vehicle;
wherein the controller is configured to:
receive the data associated with the driver,
determine a set of physical characteristics of the driver based on the data, and
automatically move the mirror from a first position to a second position based on the set of physical characteristics of the driver.

2. The system of claim 1 wherein the data associated with the driver of the vehicle includes at least one of: a position of a seat of the driver or an angle of a seat back of the seat.

3. The system of claim 1 wherein the set of physical characteristics includes at least one of: an initial location of at least one eye of the driver, an angle of the at least one eye relative to the sensor, a height of the driver, or a distance of the at least one eye from the sensor.

4. The system of claim 1 wherein the controller is configured to:
determine an initial location of at least one eye of the driver;
determine an angle of the at least one eye of the driver relative to the sensor based on the initial location; and
determine a height of the driver and a distance of the driver from the sensor based on the angle of the at least one eye of the driver to define the set of physical characteristics of the driver.

5. The system of claim 1 wherein the first position of the mirror is associated with a default position.

6. The system of claim 5 wherein the default position is associated with a determined angle of the mirror relative to a traffic line located proximate the vehicle.

7. The system of claim 1 wherein:
the controller is configured to determine the second position based on the set of physical characteristics of the driver;
the second position is different than the first position;
the driver has an obstructed view when the mirror is in the first position; and
the second position accommodates for the set of physical characteristics of the driver such that the driver has an unobstructed view when the mirror is in the second position.

8. The system of claim 1 wherein:
the controller is configured to use a machine learned model to determine the second position of the mirror; and
the machine learned model is configured to use at least one of the data from the sensor or the set of physical characteristics as an input.

9. The system of claim 1 wherein:
the system includes a second sensor; and
the controller is configured to determine a position of the mirror relative to a traffic line located proximate the vehicle based on data from the second sensor.

10. The system of claim 1 wherein:
the system includes a second mirror assembly having a second mirror; and
the controller is configured to automatically adjust a position of the second mirror based on the set of physical characteristics of the driver by moving the second mirror from a first position to a second position.

11. The system of claim 1 wherein the controller is configured to automatically move the mirror assembly, relative to a body of the vehicle, from an operational configuration to a nonoperational configuration when the vehicle is in at least one of a parked state or an off state.

12. A vehicle comprising:
the system of claim 1; and
a steering wheel,
wherein the sensor is disposed proximate the steering wheel.

13. A method comprising:
receiving, via a controller, data associated with a driver of a vehicle, wherein the data is collected by a sensor;
determining, via the controller, a set of physical characteristics of the driver based on the data; and
automatically moving, via the controller, a mirror of the vehicle from a first position to a second position based on the set of physical characteristics of the driver.

14. The method of claim 13 wherein:
the sensor is disposed proximate a steering wheel of the vehicle; and
the set of physical characteristics includes at least one of: an initial location of at least one eye of the driver, an angle of the at least one eye relative to the sensor, a height of the driver, or a distance of the driver from the sensor.

15. The method of claim 13 wherein determining the set of physical characteristics of the driver includes:
determining, via the controller, an initial location of at least one eye of the driver;
determining, via the controller, an angle of the at least one eye of the driver relative to the sensor based on the initial location; and
determining, via the controller, a height of the driver and a distance of the driver from the sensor based on the angle of the at least one eye.

16. The method of claim 13 wherein:
the driver has an obstructed view when the mirror is in the first position; and
the second position accommodates for the set of physical characteristics of the driver such that the driver has an unobstructed view when the mirror is in the second position.

17. The method of claim 13 wherein:
the controller is configured to use a machine learned model to determine the second position of the mirror; and
the machine learned model is configured to use at least one of the data from the sensor or the set of physical characteristics as an input.

18. The method of claim 13 further comprising determining, via the controller, a position of the mirror relative to a traffic line located proximate the vehicle based on data from a second sensor.

19. The method of claim 13 further comprising automatically adjusting, via the controller a position of a second mirror based on the set of physical characteristics of the driver by moving the second mirror from a first position to a second position.

20. The method of claim 13 further comprising automatically moving, via the controller, a mirror assembly including the mirror, relative to a body of the vehicle, from an operational configuration to a nonoperational configuration when the vehicle is in at least one of a parked state or an off state.
